(19) United States
(12) Patent Application Publication
(10) Pub. No.: US 2019/0184496 A1
(43) Pub. Date: Jun. 20, 2019

(54) FORMING A ROTARY PART

(71) Applicant: WEIR GROUP IP LIMITED, Glasgow (GB)

(72) Inventor: Sozon Tsopanos, Marple (GB)

(21) Appl. No.: 16/329,190

(22) PCT Filed: Aug. 30, 2017
(86) PCT No.: PCT/AU2017/050926

§ 371 Date: Feb. 27, 2019

(30) Foreign Application Priority Data
Aug. 30, 2016 (AU) 2016903451

(51) Int. Cl. B23K 26/342; B33Y 10/00; B33Y 30/00; B33Y 50/02; B28B 1/00; B29C 64/153; B29C 64/209; B29C 64/393; B23K 26/00; B23K 26/08; B23K 26/144

(52) U.S. Cl. CPC B23K 26/342; B33Y 10/00; B33Y 30/00; B33Y 50/02; B28B 1/001; B29C 64/153; B33Y 80/00; B29C 64/393; B23K 26/0093; B23K 26/0823; B23K 26/144; B23K 26/0006; B29C 64/209

(57) ABSTRACT

A method of forming a rotary part is disclosed. The method comprises (a) rotating a mandrel about an axis, (b) delivering a metal feed onto the surface of the mandrel and (c) exposing the particles at the surface to a high energy discharge so that the particles melt together to form a surface layer of metal. The method also comprises repeating steps (a) to (c) by subsequently delivering the metal feed onto the formed surface layer to form the rotary part radially from the mandrel to an outer perimeter with a desired size and shape. Also disclosed are rotary parts formed by the method and an apparatus for forming a rotary part in accordance with the method.

### FIELD OF THE INVENTION

The present disclosure relates to rotary equipment components and parts, and methods of forming them. The present disclosure has particular, but not exclusive, application to rotary parts of pumps. One common type of rotary part is an impeller, such as an impeller for valves and for liquid or slurry pumps. These valves and pumps are used in the energy sector and in mineral processing. More particularly, the disclosure relates to a method of forming such a rotary part, the rotary part formed thereby and pumps and valves that incorporate a rotary part formed thereby. The disclosure also relates to an apparatus for forming rotary parts.

### BACKGROUND

Impellers in pumps and valves that are used in minerals processing and in the energy sector are subject to very erosive conditions. As a result, the impellers are typically formed of highly wear resistant materials, such as cast iron, nickel or titanium alloys. The process of casting involves preparing a quantity of molten metal alloy in a furnace and casting the molten alloy into suitably shaped moulds. The cast impeller is removed from the mould and finished by trimming away any excess cast metal.

The impeller will have a generally uniform composition on account of being cast from a molten alloy of a particular composition. This means that low wear regions are formed of alloy with the same composition as high wear regions. This is problematic in the circumstance that the metal alloy composition includes expensive alloying element additions, e.g. niobium and nickel, which will be incorporated in regions of the impeller that are not subject to high wear. The presence of expensive alloying element additions in such regions where they provide little or no functional advantage simply adds to the overall cost of the impeller.

Given that high wear regions of impellers are typically at the outer perimeter regions, one option is to centrifugally cast the impeller. This relies on having solid, wear resistant inclusions in a host metal, so that rotation of the mould before the host metal solidifies causes the solid inclusions to concentrate at or near the outer radial perimeter of the casting. While this provides a casting with high wear regions having a higher concentration of high wear inclusions, the host metal still needs to be relatively wear resistant and, therefore, it still suffers to some extent of the same problems as mentioned above. In other words, soluble alloying elements that improve wear resistance will still be evenly dispersed throughout the casting, including in areas that are subject to low wear. For this reason, the cost of alloying elements that are soluble in the host metal can't be optimised by this method. The result is that centrifugal casting is better suited to more exotic and expensive insoluble alloying inclusions, such as niobium.

### SUMMARY OF THE DISCLOSURE

The applicant believes that the rotary parts, such as impellers for valves and pumps, that are currently manufactured by casting can be formed instead by additive manufacturing. More specifically, the applicant believes that direct metal (and other material) deposition may be used to form rotary parts having different design features that improve part performance and/or having different compositions at different locations of the part.

A method of forming a rotary part on a mandrel is provided in one aspect. The method comprises:
(a) rotating the mandrel about an axis,
(b) delivering a metal feed onto the surface of the mandrel,
(c) exposing the feed at the surface to a high energy discharge so that the particles melt together to form a surface layer of metal and
(d) repeating steps (a) to (c) by subsequently delivering the metal feed onto the formed surface layer to form the rotary part radially from the mandrel to an outer perimeter with a desired size and shape.

The composition of the metal feed may be selected depending upon the region of the rotary part being formed. It is anticipated, therefore, that the total amount of expensive alloying elements that is used to form a rotary part by the method according to the above aspect will be less than the total amount of expensive alloying elements that is included in a casting of a rotary part because the expensive alloying element are incorporated into selected target regions of the rotary part. This means that a rotary part may be produced from feed materials that have a lower overall cost compared to the cost of feed materials used to form the same rotary part by casting.

In one embodiment, step (b) is replaced by the step of delivering a material feed onto the surface of the mandrel, where the material is non-metal.

In one embodiment, step (b) comprises the sub-steps of (b1) identifying a metal feed source from a plurality of feed sources based on a specified non-dimensional criterion for a portion of the rotary part to be formed, (b2) selecting the identified metal feed source and (b3) delivering the metal feed from the selected metal feed source onto the surface of the mandrel.

In accordance with this embodiment, the step of identifying the metal feed source includes: accessing a digital design file of the rotary part, using three dimensional position information from the apparatus creating the rotary part to locate a relevant portion of the digital design file corresponding to a portion of the rotary part that is to be formed, and reading the specified criterion from the relevant part of the digital design file.

The digital design file may divide the rotary part into concentric rings that are centered on the rotary axis of the rotary part, the rings can have different specified criterion such that the identification and selection of the feed material source depends upon which ring includes the portion of the rotary part that is to be formed.

The specified criterion may include a hardness factor indicating the required hardness of material for that portion of the rotary part.

The method may include monitoring the angle of rotation of the rotary part during formation to enable the metal feed source to be correctly selected from the relevant portion of the digital design file.

The rings may have a radial thickness in the range of 50 μm to 3 mm.

In one embodiment, the metal feed source comprises a plurality of sources. Each has a different metal feed composition that is associated with a different specified criterion after the metal feed source is delivered and exposed to the high energy discharge. According to this embodiment, the metal feed may comprise wear resistant metal for high wear regions of the impeller and the metal feed may comprise an alternative composition for regions of the impeller that are subject to less wear than the high wear regions.

In another embodiment, the metal feed source comprises a plurality of sources, including a base alloy feed source and a plurality of alloying component feed sources and wherein step (b1) includes identifying a blend of the base alloy feed source with one or more of the alloying component feed sources that will provide the metal feed source with the specified criterion for the portion of the rotary part to be formed. In accordance with the embodiment, the plurality of alloying component feed sources may include alloying components that are soluble in the base alloy and includes alloying components that are insoluble in the base alloy.

Optionally, the composition of the metal feed may be varied to provide the rotary part with a graded composition in terms of wear resistance between high wear and low wear regions.

The high energy discharge may comprise a laser beam, an electron beam or an electric arc.

The metal feed can be in either powder or wire form. Accordingly, in the embodiment of the feed metal comprising powder, step (b) may comprise delivering a stream of metal particles to the surface layer. The stream of metal particles may be entrained in an inert carrier gas. Alternatively, the metal feed may be a wire that is fed at a selected feed rate.

Optionally, steps (b) and (c) may occur simultaneously at multiple locations around the mandrel so as to form the surface layer at the multiple locations around the mandrel simultaneously.

The method may include additional steps for finishing operations which occur either simultaneously with steps (a) to (c) or sequentially. The finishing operations may occur at multiple locations around the mandrel or may occur overall.

The finishing operations may include one or more of the following: heat treatment, machining, turning, grinding, autofrettage (or other pressure treatment), and a treatment to improve the surface finish (for example, to facilitate bonding of another material, to reduce friction, or the like). Surface finish treatments include heat treatment by laser, electron beam or electric arc to decrease surface roughness or to alter the chemistry of the rotary part at the surface. For example, the surface finish treatment may include interstitial elemental absorption, for example, nitriding or carburizing.

Formation of the rotary part may be interrupted to allow for machining of internal features or surfaces.

The method may further comprise depositing elastomeric material, plastics material, carbon fibre with embedding plastics or ceramic material on the formed rotary part.

Another aspect provides a rotary part formed in accordance with the method aspect.

A further aspect provides a rotary part including a housing having an inlet and an outlet and an impeller disposed in the housing such that rotation of the rotary part pumps fluid or slurry from the inlet to the outlet and wherein the rotary part is formed in accordance with the method aspect.

In a further aspect, there is provided an apparatus for forming a rotary part, such as a pump or valve impeller. The apparatus comprises:
(a) a deposition head defining an annular passage and including a high energy discharge;
(b) a mandrel support configured to align a mandrel with the deposition head and rotate the mandrel about an axis so as to form the rotary part on the mandrel;
(c) a first feed source storing first material feed and being in fluid communication with the annular passage for delivering a metal feed therethrough;
(d) a second feed source storing second material feed having different properties to the first material feed, and being in fluid communication with the annular passage for delivering a feed material therethrough; and
(e) a controller operable to: identify a portion of the rotary part to be formed, select one of the feed sources based on a specified non-dimensional criterion associated with the corresponding portion of the rotary part in a digital design file and deliver feed from the selected feed source to the mandrel or a previously formed portion of the digital design file.

In accordance with this aspect, the controller may be operable to (i) record three dimensional position information of the deposition head during forming of the rotary part, (ii) access a digital design file for the rotary part, (iii) use the recorded three dimensional position information to locate the corresponding portion of the digital design file, (iv) read the specified non-dimensional criterion associated with the corresponding portion of the digital design file, (v) use the read specified non-dimensional criterion to select one of the feed sources which meets or is closest to the specified non-dimensional criterion; and (vi) deliver feed from the selected feed source onto the mandrel or a previously formed portion of the rotary part, and repeat (i) through (vi) as necessary until a rotary part having a size, shape, and properties specified in the digital design file is formed.

The first feed source may comprise a metal feed. The second feed source may be a different feed material to the first feed source and may be a different metal composition or may be a non-metal feed material.

The specified non-dimensional criterion may relate to hardness, ductility, coefficient of friction, or microstructure.

The controller may be configured to control operation of the deposition head in response to the read specified non-dimensional criterion by adjusting one or more of a standoff distance between the deposition head and the rotary part being formed, a feed rate from the first and/or second feed sources and the energy of the high energy discharge.

### BRIEF DESCRIPTION OF THE DRAWINGS

Notwithstanding any other forms which may fall within the scope of the disclosure as set forth in the Summary, specific embodiments will now be described by way of example and with reference to the accompanying drawings in which:

FIG. 1 is a schematic representation of an embodiment of an apparatus and process for forming a layer of metal on a substrate.

FIG. 2 is a more detailed schematic representation of the apparatus that performs the method shown in FIG. 1.

FIG. 3 is a schematic representation of the process shown in FIG. 1 as applied to forming a rotary part about a mandrel.

FIG. 4 is a schematic representation showing layer-by-layer construction of an impeller by the method shown in FIG. 3, but with multiple depositions heads located about the bar or mandrel.

FIG. 5 is a schematic flow chart showing an embodiment of a method of preparing a rotary part as described above.

### DETAILED DESCRIPTION

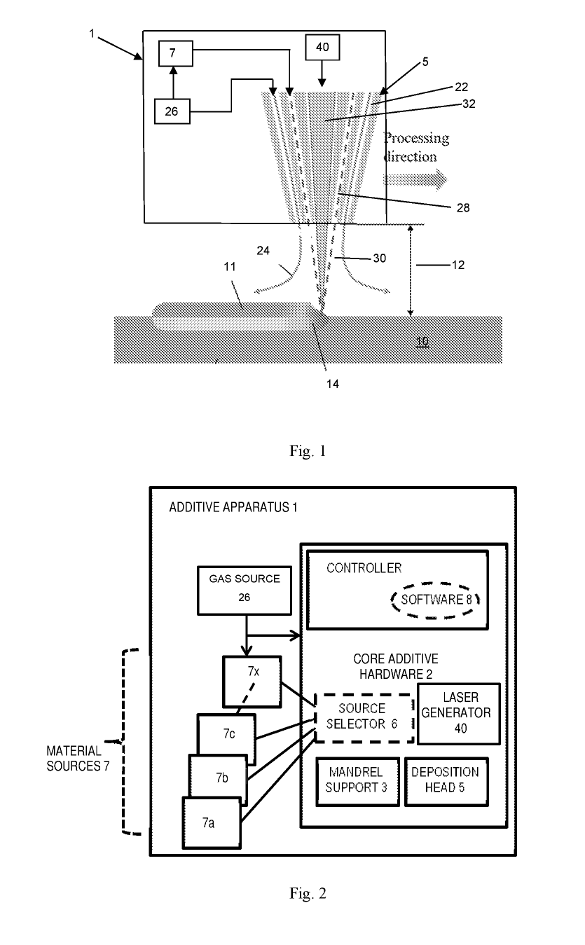

FIG. 1 schematically shows a deposition process for forming a layer 11 of deposited metal material on a work piece 10. FIG. 1 also shows some aspects of an apparatus 1 for performing the process. More details of the apparatus 1 are outlined below in reference to FIG. 2

The process includes bringing a deposition head 5 into close proximity to the work piece 10 so that there is a small stand-off distance 12 between the deposition head 5 and the work piece 10. The deposition head 5 includes an annular passage 22 for conveying shielding gas 24 from a source 26, through the deposition head 5 and onto the work piece 10. The shielding gas 24 is inert gas, for example nitrogen or argon, so as to exclude oxygen in the ambient environment from a melt pool 14. This, therefore, avoids oxidation of molten metal in the melt pool 14.

The deposition head 5 also includes an annular passage 28 for delivering a stream of powdered metal 30 to the work piece 10. The stream of powdered metal 30 is conveyed in a carrier gas, which is also inert gas, from the gas source 26. Accordingly, in the embodiment shown in FIGS. 1 and 2, the shielding gas and the carrier gas are the same gas. Accordingly, the gas source 26 is in fluid communication with (a) the deposition head 5 to deliver gas as a shielding gas via the annular passage 22 and (b) a feed material 7 to fluidise the feed material and to form a stream 30 of entrained powdered metal that is delivered to the work piece 10 via the annular passage 28. It will be appreciated, however, that the shielding gas 24 and the carrier gas may alternatively be different gases from different sources.

The processing head 5 further includes a laser generator 40 that is configured to direct a laser beam 32 onto the work piece 10.

The shielding gas 24, the stream of powdered metal 30 and the laser beam 32 are focussed on a target zone on the work piece 10 opposite the deposition head 5.

The deposition head 5 may have alternative configurations. For example, the shielding gas 24 and the stream of powdered metal 30 may be combined to flow through a single annular passage so that the shielding gas 24 acts as the carrier gas for the powdered metal 30. Additionally, the laser generator 40 may be separate from the deposition head 5 and yet arranged to focus a laser beam 32 on the target zone to which the shielding gas 24 and the powdered material stream 30 are delivered. However, the configuration of the deposition head is not critical to operation of the method described below.

In a further alternative, the stream of powdered metal 30 may be replaced with a feed wire which is advanced into the target zone on the work piece 10 by the deposition head 5. The deposition head 5 controls the feed rate of the feed wire so that the feed wire is exposed to the laser beam 32 for long enough to melt and form part of the melt pool 14.

Additionally, the laser beam 32 may be replaced with other high energy discharge sources, such as an electron beam or an electric arc. In either case, the high energy discharge must provide sufficient energy to melt a localised region of the work piece, so as to form the melt pool, and melt the powdered metal 30 or feed wire delivered to the melt pool 14 of the work piece 10.

FIG. 2 shows a schematic diagram illustrating apparatus 1 for forming a rotary part, such as an impeller, according to one embodiment of the invention. For simplicity, the deposition head 5 shown in FIG. 1 is shown schematically in FIG. 2, but otherwise is the same deposition head 5.

The apparatus 1 includes a modified version of an additive manufacturing machine 2 (referred to herein as core additive hardware). A suitable additive manufacturing machine that can be used as core additive hardware 2 is the Trulaser Cell 3000 (trade mark) available from The Trumpf Group (see, for example, https://www.trumpf.com/en_INT/products/machines-systems/laser-welding-systems/trulaser-cell-3000/).

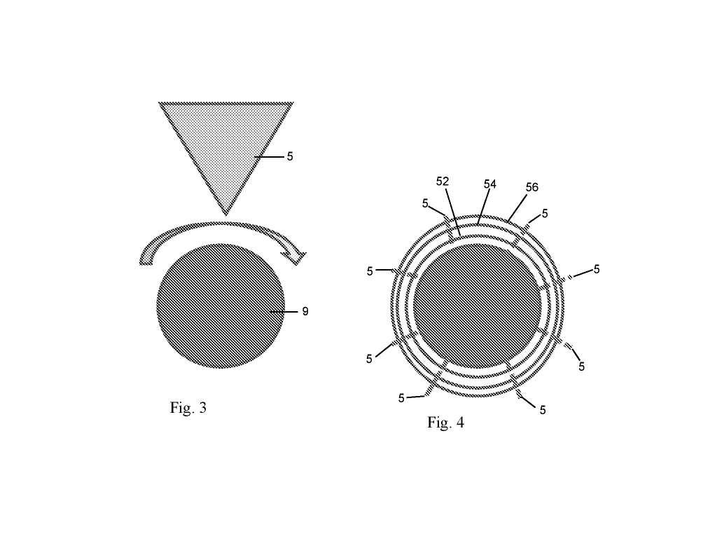

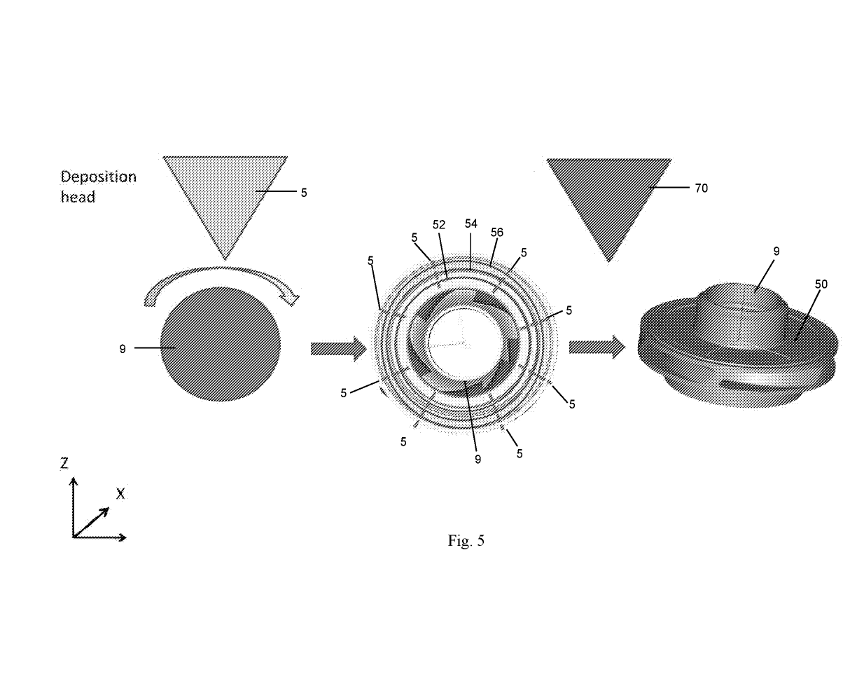

The core additive hardware 2 includes a mandrel support 3 that is operable to support and rotate a mandrel 9 (FIG. 3) during deposition of material thereon, thereby allowing radial deposition of material onto the mandrel 9. The core additive hardware 2 also includes a programmable controller 4 and at least one deposition head 5 aligned with the mandrel support 3. In some embodiments, multiple deposition heads may be provided.

The core additive hardware 2 has been modified by adding a source selector 6 (shown in broken line because it is not part of off-the-shelf core additive hardware 2 but has been added to create apparatus 1).

The apparatus 1 further comprises a plurality of feed sources 7 (labelled 7a to 7x in FIG. 2) arranged to feed material therefrom to the core additive hardware 2. It will be appreciated that the exact number of feed sources 7 chosen may depend on the particular application for the rotary part being formed. The modified core additive hardware 2 uses the source selector 6 to select the desired feed source 7 for each particular feature of a rotary part being formed by the apparatus 1.

The apparatus 1 further comprises software 8 (shown in broken line because it is not part of off-the-shelf core additive hardware 2 but has been added to create apparatus 1). The software 8 is provided for transforming the core additive hardware 2 into apparatus that is suitable for forming rotary parts. The software 8 includes a digital design file (also referred to as a digital file) that is similar to a CAD file in that it provides three dimensional information about the rotary part that is to be formed, but also includes additional information. For example, the digital design file comprises slices of information that can be accessed by the controller 4 to energize the deposition head 5 to deposit material from one or more of the plurality of sources 7.

In this embodiment, the apparatus 1 deposits layers of material for one or more revolutions of the mandrel support up to a predetermined deposition depth (typically in the range from 50 microns to 3 mm) then moves the mandrel horizontally so that the entire length (or at least the entire length on which deposition is desired) of a mandrel is built up to the deposition depth before another deposition depth is laid down on the entire length of the mandrel.

The digital design file also includes what is referred to as a toolpath for each layer. The toolpath includes information such as the movement of the deposition head 5 needed to deposit the required material, the deposition head power to be used (for example, where the deposition head 5 includes a laser, the laser power is specified by the digital design file), which feed source 7 is to be used for each portion of the rotary part being deposited, the speed of rotation of the mandrel support 3, and the flow rate of each feed source 7.

In other embodiments, the source selector 6 may include a mixer to mix materials from a plurality of feed sources 7 in desired proportions to create a feed material having desired properties.

Having regard to FIG. 1, in operation, the stream of powdered metal 30 delivered to the surface of the work piece 10 is melted by the laser beam 32, together with a localised region of the work piece 10 so that a common melt pool 14 is formed. The liquid metal contributed by melting the powdered metal 30 forms part of the melt pool 14 and, upon solidification of the metal pool 14, forms part of a surface layer 11 which is integrated metallurgically with the work piece 10. This deposition process continues as the deposition head 5 advances across the surface of the work piece 10 so that the layer 11 of deposited material extends over the surface of the work piece 10. In this way, the work piece 10 can be built up layer-by-layer to a desired shape and size.

In regard to forming a rotary part, such as an impeller 50, the deposition head 5 (see FIG. 3) is located adjacent the surface of the mandrel 9, such as a bar or tube, so that the deposition process shown in FIG. 1 can be carried out circumferentially over the surface of the mandrel 9 as the mandrel 9 is rotated about its longitudinal axis. As described above, the deposited structure is grown layer-by-layer as shown in FIG. 4 by the concentric rings (52, 54, 56) that are disposed about the mandrel 9 and centered on the longitudinal axis of the mandrel 9. In effect, the impeller 50 is formed in a generally radially outward direction from surface of the mandrel 9 having regard to the longitudinal axis of the mandrel 9.

As shown in FIG. 4, the deposited structure which forms the impeller 50 comprises a series of concentrically formed rings or segments of rings. This is achieved by slicing the design of the impeller, such as in a computer-generated design file, into narrow concentric rings and ring segments and then operating the deposition head 5 to form the rings and ring segments. More specifically, a ring is formed by operating the disposition head 5 continuously until the ring is formed. However, ring segments are formed by operating the deposition head 5 to deposit metal and build-up the surface layer in a portion of the ring or in portions of the ring. This will, therefore, leave gaps in the overall structure of the impeller 50 so as to coincide with the overall impeller 50 design which may include channels or grooves for motivating the flow of fluids or slurries.

Dividing the design of the rotary part into the concentric parts 52, 54, 56 (including rings and ring segments) enables the different concentric parts to be ascribed a specific non-dimensional criterion. This criterion may relate to the hardness, ductility, coefficient of friction, or microstructure of the impeller in that ring or ring segment.

Having regard to hardness, for example, dividing the impeller 50 design into rings and ring segments allows the hardness of those rings and ring segments to be allocated within the design file depending on the anticipated wear of the impeller 50 at the various locations of the rings and ring segments. The information on the hardness of the rings and ring segments can then be read from the design file during formation of the impeller 50 and can be used to control the composition of the metal feed used to form the ring or ring segment. It follows that the hardness of the impeller 50 will vary radially between areas that are subject to low wear and areas that are subject to high wear, i.e. typically the perimeter regions of the impeller 50 which coincide with concentrically outer rings and/or ring segments in the impeller design.

Having regard to FIG. 4, for example, the process for forming an impeller includes reading a design file of the impeller, including reading the non-dimensional criterion associated with the inner concentric ring 52. Being, the inner concentric ring 52 adjacent the mandrel, the ring 52 typically possesses structural properties for supporting the intermediate ring 54 and the outer ring 56 and, therefore, typically has a high tensile strength with good ductility, but hardness is not an important factor because the inner ring is not exposed to high wear conditions. Accordingly, the non-dimensional criterion may indicate low hardness. The composition of the metal feed, therefore, is selected accordingly and is delivered to the mandrel so as to construct the inner ring 52 in the manner described above. The intermediate ring 54 is, however, subject to more erosive conditions, but still plays a structural role. The non-dimensional criterion, therefore, indicates that a more wear resistant material than the material used to form the inner ring 52 is required. Accordingly, the composition of the feed material is selected and is then delivered to the surface of the inner ring 52 to construct the intermediate ring 54 in the manner described above. Once the intermediate ring 54 is formed, the outer ring 56 is prepared in the same manner by referring to the design file for the associated non-dimensional criterion. In this instance, the criterion indicates that high hardness is required of the outer ring 56 because it is subject to high wear conditions. Accordingly, the composition of the feed material is selected and is then delivered to the surface of the intermediate ring 54 to construct the outer ring 56 in the manner described above.

Selection of the feed material is based on tracking the three-dimensional location of the deposition head 5 relative to the corresponding three-dimensional location in the design file. The non-dimensional criterion associate with the ring or ring segment is used to identify and select the feed material for constructing that part of the impeller. Once selected, the feed material is delivered to the surface of the mandrel or already formed surface while it rotates so as to radially build-up the impeller from the mandrel to its outer perimeter.

The rings and ring segments in the design file may have a radial thickness in the range of 50 microns to 3 mm. Furthermore, the thickness may vary depending on the location of the ring or ring segment in the rotary part. For example, rings or segments near the mandrel may have a larger radial thickness than rings and ring segments near the perimeter of the rotary part where variations in the non-dimensional criterion are more pronounced.

By forming a rotary part from a mandrel 9 having a bore of a required diameter for mounting on a drive shaft, the formed rotary part (which incorporates the mandrel 9) can be mounted directly onto the drive shaft without requiring any further processing steps.

It will be appreciated, therefore, that the composition of the impeller, or other rotary part formed in accordance with the method described here, may be radially variable. It will further be appreciated that the rotary part may have a composition that varies circumferentially, optionally in addition to the radial variation. This is a significant advance on rotary parts formed by casting molten metal which have a uniform composition throughout and which is primarily dictated by the performance requirements of, for example, the high wear portions of the rotary part. However, rotary parts that are formed according to the method described above can have the three-dimensional functionally variable composition tailored to the specific performance requirements over the three-dimensions of the rotary part. This means that the expensive highly wear resistant materials can be concentrated into the high wear areas, thus providing a cost saving compared with uniform compositions of cast rotary parts.

In the embodiment shown in FIGS. 1 and 2, the feed material comprises feeds (7a to 7x) from a number of different feed sources where “x” corresponds to the number of different non-dimensional criteria in the design file. For example, there are six different feed sources when the design file includes six different non-dimensional criteria. More specifically, a design file having six different regions of a rotary part, each with a different hardness, will require a feed material that has six different feed compositions to provide the relevant portions of the rotary part with the six different hardnesses (although in some embodiments, a smaller number of feeds may be selectively mixed in different quantities to provide more compositions than there are feeds). Each feed source may be based on a base metal alloy, such as cast iron, and include an incrementally higher proportion of one or more alloying elements that is selected to improve the hardness of the resulting alloy. Alternatively, each feed source may be a different alloy composition. For example, one alloy may be a high strength steel and other alloys may be incremental variations in composition between the steel and a wear resistant cast iron.

In another embodiment, the feed material may comprise two feed sources; one being a base alloy and the other being alloying additions which, when combined with the base alloy, provide a more wear resistant resulting alloy. For example, one feed course may be a cast iron alloy and the second feed source may be a mixture of alloying elements that form precipitates in a metal alloy, e.g. chromium carbide, vanadium carbide and niobium carbide. The mixture may also include alloying elements that strengthen or harden the alloy through dissolving into the solid solution matrix. In this manner, the non-dimensional criterion (e.g. wear resistance) of a ring or ring segment can be controlled by adjusting the blend of the base alloy and the alloying additions of the feed material delivered to the mandrel or the previously formed surface.

In each embodiment, the delivery of feed material is controlled by the controller 4 (FIG. 2) as part of the apparatus 1. Accordingly, the controller 4 controls the selection and delivery of feed materials from the feed material source (7a to 7x) to the annular passage 28 through which the feed material is delivered to the mandrel 9.

The controller 4 records three dimensional position information of the deposition head 5 during forming of the rotary part. The controller 4 accesses the digital design file for the rotary part and uses the recorded three dimensional position information to locate a corresponding portion of the digital design file. The controller 4 reads a specified non-dimensional criterion associated with the corresponding portion and uses the read specified non-dimensional criterion to select one of the feed sources (7a to 7x) which meets or is closest to the specified non-dimensional criterion. The controller 4 then delivers feed from the selected feed source onto the mandrel 9 or a previously formed portion of the rotary part. These steps are repeated as necessary until a rotary part having a size, shape, and properties specified in the digital design file is formed.

It is anticipated that this method of forming a rotary part enables open and closed impellers to be formed. In that regard, the process for forming the rotary part may cut-off access to portions of the rotary part that require surface finishing, e.g. machining and/or grinding It is anticipated, therefore, that the process is interrupted at the required times and the finishing operation 70 is completed while access remains. Once the finishing operation 70 is completed, the process of forming the rotary part is continued.

It is anticipated that this method will enable the impellers to be formed more quickly than conventional casting methods and will remove design and material constraints associated with forming impellers by conventional casting techniques.

Optionally, multiple deposition heads may be located about the bar to form deposition layers simultaneously. It is anticipated that adopting multiple deposition heads will reduce the time to form impellers by this method.

It is further anticipated that a range of materials may be used to form rotary parts by the method described above. For example, nickel, titanium, aluminium and alloys of cobalt and chromium may be used to form rotary parts, such as impellers. Furthermore, the feed source may include elastomeric materials for applying rubber or plastics to the surface of a rotary part during formation or after it has been formed.

Furthermore, the size of impellers may be produced by this method is anticipated to be up to 1 m×0.5 m×2 m.

The use of a laser, electron beam or electric arc is anticipated to provide dimensional accuracy to approximately 50 microns and a surface roughness (Ra) in the range of 5 to 100 microns. The layer thickness of each deposition layer is anticipated to be in the range of approximately 50 microns to 3 millimetres.

Suitable particle sizes for the powdered metal may be in the range of approximately 15 microns to 150 microns.

Furthermore, it is anticipated that the method will reduce manufacturing defects and, therefore, will reduce the amount of material that is discarded as scrap. It is also anticipated that the method will reduce post-machining times and costs.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, for example, aspects of one embodiment may be combined with aspects of another embodiment to realize yet other embodiments.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms. The terms “vertical” and “horizontal” when used in reference to the impeller throughout the specification, including the claims, refer to orientations relative to the normal operating orientation of a rotary part (such as an impeller in a pump or valve).

1-31. (canceled)

32. A method of forming an impeller, the method comprising:
(a) rotating a mandrel about an axis;
(b) delivering a metal feed onto the surface of the mandrel;
(c) exposing particles at the surface to a high energy discharge so that the particles melt together to form a surface layer of metal;
(d) delivering a non-metal feed onto the surface;
(e) exposing particles at the surface to a high energy discharge so that the particles melt together to form a surface layer;
(f) repeating steps (a) to (e) by subsequently delivering the metal and non-metal feed onto the formed surface layer to form the impeller radially from the mandrel to an outer perimeter with a desired size and shape; and
(g) interrupting formation of the impeller to allow for surface finishing.

33. The method defined in claim 32, wherein the composition of the metal feed is selected depending upon the region of the impeller being formed.

34. The method defined in claim 32, wherein step (b) comprises the sub-steps of:
(b1) identifying a metal feed source from a plurality of feed sources based on a specified non-dimensional criterion for a portion of the impeller to be formed,
(b2) selecting the identified metal feed source; and
(b3) delivering the metal feed from the selected metal feed source onto the surface of the mandrel.

35. The method defined in claim 34, wherein the step of identifying the metal feed source includes: accessing a digital design file of the impeller, using three dimensional position information of the part formed so far to locate a relevant portion of the digital design file corresponding to a portion of the impeller that is to be formed, and reading the specified criterion from the relevant part of the digital design file.

36. The method defined in claim 34, wherein the digital design file divides the impeller into concentric rings that are centered on the rotary axis of the impeller, the rings can have different specified criterion such that the identification and selection of the feed material source depends upon which ring includes the portion of the impeller that is to be formed.

37. The method defined in claim 34, wherein the specified non-dimensional criterion includes a hardness factor indicating the required hardness of material for that portion of the impeller.

38. The method defined in claim 34, wherein the method includes monitoring the angle of rotation of the impeller during formation to enable the metal feed source to be correctly selected from the relevant portion of the digital design file.

39. The method as defined in claims 34, wherein the metal feed source comprises a plurality of sources, each with a different metal feed composition that is associated with a different specified criterion after the metal feed source is delivered and exposed to the high energy discharge.

40. The method defined in claim 39, wherein one of the plurality of metal feed sources comprises wear resistant metal for high wear regions of the impeller and at least one of the remaining metal feed sources comprises an alternative composition for regions of the impeller that are subject to less wear than the high wear regions.

41. The method as defined in claim 34, wherein the metal feed source comprises a plurality of sources, including a base alloy feed source and a plurality of alloying component feed sources and wherein step (b1) includes identifying a blend of the base alloy feed source with one or more of the alloying component feed sources that will provide the metal feed source with the specified criterion for the portion of the impeller to be formed.

42. The method defined in claim 41, wherein the plurality of alloying component feed sources includes alloying components that are soluble in the base alloy and includes alloying components that are insoluble in the base alloy.

43. The method defined in claim 41, wherein, the composition of the metal feed is varied to provide the impeller with a graded composition in terms of wear resistance between high wear and low wear regions.

44. The method defined in claim 32, wherein the surface finishing includes one or more of the following: heat treatment, machining, turning, grinding and a treatment to improve the surface finish.

45. The method defined in claim 32, wherein steps (b) and (c) occur simultaneously at multiple locations around the mandrel so as to form the surface layer at the multiple locations around the mandrel simultaneously.

46. The method as defined in claim 32, wherein step (d) comprises depositing elastomeric material, plastics material, carbon fibre with embedding plastics or ceramic material on the formed impeller.

47. An apparatus for forming an impeller, the apparatus comprising:
(a) a deposition head defining an annular passage and including a high energy discharge;
(b) a mandrel support configured to align a mandrel with the deposition head and rotate the mandrel about an axis so as to form the impeller on the mandrel;
(c) a metal feed source storing first material feed and being in fluid communication with the annular passage for delivering a metal feed therethrough;
(d) a non-metal feed source storing second material feed having different properties to the first material feed, and being in fluid communication with the annular passage for delivering a non-metal feed material therethrough; and
(e) a controller operable to: identify a portion of the impeller to be formed, select one of the feed sources based on a specified non-dimensional criterion associated with the corresponding portion of the impeller in a digital design file and deliver feed from the selected feed source to the mandrel or a previously formed portion of the digital design file.

48. The apparatus defined in claim 47, wherein the controller is operable to (i) record three dimensional position information of the deposition head during forming of the impeller, (ii) access a digital design file for the impeller, (iii) use the recorded three dimensional position information to locate a corresponding portion of the digital design file, (iv) read a specified non-dimensional criterion associated with the corresponding portion of the digital design file, (v) use the read specified non-dimensional criterion to select one of the feed sources which meets or is closest to the specified non-dimensional criterion; and (vi) deliver feed from the selected feed source onto the mandrel or a previously formed portion of the impeller, and repeat (i) through (vi) as necessary until a impeller having a size, shape, and properties specified in the digital design file is formed.

49. The apparatus of claim 47, wherein the specified non-dimensional criterion relates to hardness, ductility, coefficient of friction, or microstructure.

50. The apparatus of claim 47, wherein the controller is configured to control operation of the deposition head in response to the read specified non-dimensional criterion by adjusting one or more of a standoff distance between the deposition head and the impeller being formed, a feed rate from the first and/or second feed sources and the energy of the high energy discharge.

51. The apparatus of claim 47, wherein the apparatus comprises a plurality of deposition heads, each deposition head being individually and separately controlled by the controller.
